(19) United States
(12) Patent Application Publication
(10) Pub. No.: US 2019/0221982 A1
(43) Pub. Date: Jul. 18, 2019

(54) METHOD FOR INSULATING AN ELECTRICAL CONNECTING DEVICE HOUSING AGAINST THE ELECTROMAGNETIC WAVES AND A HOUSING OBTAINED BY IMPLEMENTING THIS METHOD

(71) Applicant: AMPHENOL - AIR LB, Carignan (FR)

(72) Inventors: Anthony WANSCHOOR, Sedan (FR); Bruno WAFFLART, Pure (FR); Dang Quang TA, Blagny (FR)

(21) Appl. No.: 16/246,893

(22) Filed: Jan. 14, 2019

(30) Foreign Application Priority Data
Jan. 16, 2018 (FR) 18 50359

(51) Int. Cl. H01R 43/20; H01R 13/03; H01R 13/6581; H01R 13/504

(52) U.S. Cl. CPC H01R 43/20; H01R 13/504; H01R 13/6581; H01R 13/03

(57) ABSTRACT

A method for insulating a housing of an electrical connecting device against the electromagnetic waves includes a housing made of an electrical insulating material, and the housing has at least one cavity. The method includes closing the cavity and metallizing at least part of an outer surface of the housing. The cavity is closed by overmolding an overmolding material on this housing. The overmolding material and the housing of the electrical connecting device are separated, after the step of metallizing.

### CROSS-REFERENCE TO RELATED APPLICATIONS

See Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

### 1. Field of the Invention

The present invention relates to a method for insulating an electrical connecting device housing against the electromagnetic waves, as well as to an electrical connecting device housing obtained by implementing this method.

### 2. Description of Related Art Including Information Disclosed Under 37 CFR 1.97 and 37 CFR 1.98

The invention relates to the field of the manufacture of electrical components, more particularly to the field of the manufacture of electrical connecting devices for ensuring an electrical connection of at least one electrical cable with at least another electrical cable, namely of at least part of the electrical cables of at least one bundle of electrical cables, each with at least another electrical cable of at least another bundle of electrical cables.

Such an electrical connecting device comprises a housing, which includes at least one cavity for receiving each either at least one electrical connecting organ (even at least one electric cable associated with such an electrical connecting organ), or at least one insert receiving or intended to receive at least one such electrical connecting organ (even at least one such electric cable).

In this respect, it should be observed that inside the housing the electrical signal conveyed by such an electric cable may be sensitive to the electromagnetic waves, which are external to the housing, and which are likely to interfere with this electrical signal being conveyed and thus degrade the quality of this electrical signal being conveyed. Conversely, the electrical signal conveyed by such an electric cable can generate, outside the housing, electromagnetic waves, which are likely to interfere with another electrical signal outside the housing, namely an electrical signal within an electrical component outside the housing.

In order to ensure an insulation of such an electrical connecting device housing against the electromagnetic waves, it is known to coat such a housing with a metal coating.

One solution then consists in applying a metal or metallized casing over this electrical connecting device housing. This solution involves designing, manufacturing, storing, conveying, providing and placing (or even fastening) on the electrical connecting device housing an additional part, namely the metallic or metallized casing. In addition to the fact that this additional part increases the overall manufacturing cost of the electrical connecting device, this metallic or metallized casing only coats part of the electrical connecting device housing and, hence, only provides a reduced insulation against electromagnetic waves.

Another solution consists, on the one hand, in metallizing part of the electrical connecting device housing by coating only part of the outer surface of this housing with a layer of metal or a metal alloy and, on the other hand, in preserving areas of this housing that must not be conductive, so as to maintain the electrical insulation between the power lines. To this end, within the framework of the manufacture of such an electrical connecting device housing, it is known to close the cavity or cavities (intended to receive at least one electrical connecting organ, even at least one electrical cable associated with such a connecting organ, or an insert receiving or intended to receive at least one such connecting organ, even at least one such electrical cable) of this housing by means of at least one stopper, before proceeding to the metallization of this housing. This then requires to design, manufacture, store, convey, provide, place (prior to the metallization) and to remove (after the metallization) such stoppers. In addition to the fact that these stoppers are, here too, additional parts that increase the overall manufacturing cost of the electrical connecting device, the placing of these stoppers is necessarily performed manually, which extends the manufacturing time and complicates the method for manufacturing the electrical connecting device. In addition, it should be observed that this or these stoppers do not always permit to guarantee an appropriate closing of the cavities of the housing, which, during the metallization phase, causes leakage of the metallization product and contamination of the areas that must be preserved. This results into quality defects in the housings and in the devices, which, as a result, are discarded. This drawback is amplified by the fact that it is particularly difficult to check the quality of the closing made by means of this or these stoppers, during the placing of such a stopper, prior to the metallization and after the metallization.

### BRIEF SUMMARY OF THE INVENTION

The present invention is intended to cope with the drawbacks of the methods for electromagnetic protection of the electrical connecting device housings of the state of the art as well as of the housings obtained by implementing these methods.

To this end, the invention relates to a method for insulating an electrical connecting device housing against the electromagnetic waves, this housing is made of an electrical insulating material and includes at least one cavity. The method for insulating consists in that:
the cavity or cavities of the electrical connecting device housing are closed;
then, at least part of the outer surface of this housing is metallized.

This method is characterized in that:
the cavity or cavities of the electrical connecting device housing are closed by overmolding an overmolding material on this housing;
after metallization, the overmolding material and the electrical connecting device housing are separated.

Another feature consists in that overmolding material is overmolded by injecting this overmolding material at least into the cavity or cavities of the electrical connecting housing.

The method also consists in that means for receiving an organ for handling and/or holding the electrical connecting device housing are defined.

The invention also relates to an electrical connecting device housing, this housing being made of an electrical insulating material, including at least one cavity, and being obtained by implementing the above-described method.

The invention also relates to an electrical connecting device including such a housing.

Finally, the invention relates to an assembly including, on the one hand, an electrical connecting device housing, this housing being made of an electrical insulating material and including at least one cavity and, on the other hand, means for closing the cavity or cavities of the housing, wherein the closing means are formed of an overmolding material, which is overmolded on this electrical connecting device housing and which extends at least inside of the cavity or cavities of this housing.

Thus, the invention relates to a method for insulating an electrical connecting device housing against the electromagnetic waves.

This method consists, in particular, in that part of the electrical connecting device housing is metalized, which advantageously permits to avoid using a metal or metallized housing, which, on the one hand, forms an additional part for such a housing and, hence, for such a device and, on the other hand, reduces the electromagnetic protection surface of such a housing.

This method also consists in that, prior to metallizing part of the electrical connecting device housing, the cavity or cavities of this housing are closed by an overmolding material on this housing.

This feature advantageously permits to avoid making use of stoppers having the above-mentioned drawbacks and, in particular, to avoid a manufacturing step consisting in manually placing such stoppers at the level of the cavity or cavities of an electrical connecting device housing as well as the cost of such a manufacturing step.

This feature also advantageously permits to adequately close the cavity or cavities of the electrical connecting device housing so that, during and after the metallization of this housing, any leakage of metallization product and, hence, any contamination of the areas that must be preserved and that thus remain preserved, is avoided.

This results into an improvement of the manufacturing quality of the electrical connecting device housings and, hence, into a reduction of the manufacturing cost of these housings and, a fortiori, of the electrical connecting devices.

Further aims and advantages of the present invention will become evident from the following description relating to embodiments, which are given only by way of indicative and non-restrictive examples.

### BRIEF DESCRIPTION OF THE SEVERAL VIEWS OF THE DRAWINGS

The understanding of this description will be facilitated when referring to the attached drawings.

FIG. 1 is a schematic perspective view of an electrical connecting device housing, prior to implementing the method for insulating according to the invention.

FIG. 2 is a schematic perspective view of the electrical connecting device housing shown in FIG. 1, after a first step of the method for insulating this housing.

FIG. 3 is a perspective view similar to FIGS. 1 and 2 and corresponds to the electrical connecting device housing shown in FIGS. 1 and 2, after a second step of the method for insulating according to the invention.

FIG. 4 is a perspective view similar to FIGS. 1 to 3 and corresponds to the electrical connecting device housing shown in FIGS. 1 to 3, after a third step of the method for insulating according to the invention.

FIG. 5 is a perspective view similar to FIGS. 1 to 4 and shows an electrical connecting device including, on the one hand, a housing obtained by implementing the method for insulating according to the invention, and, on the other hand, an insert intended to receive at least part of the means permitting to ensure an electrical connection.

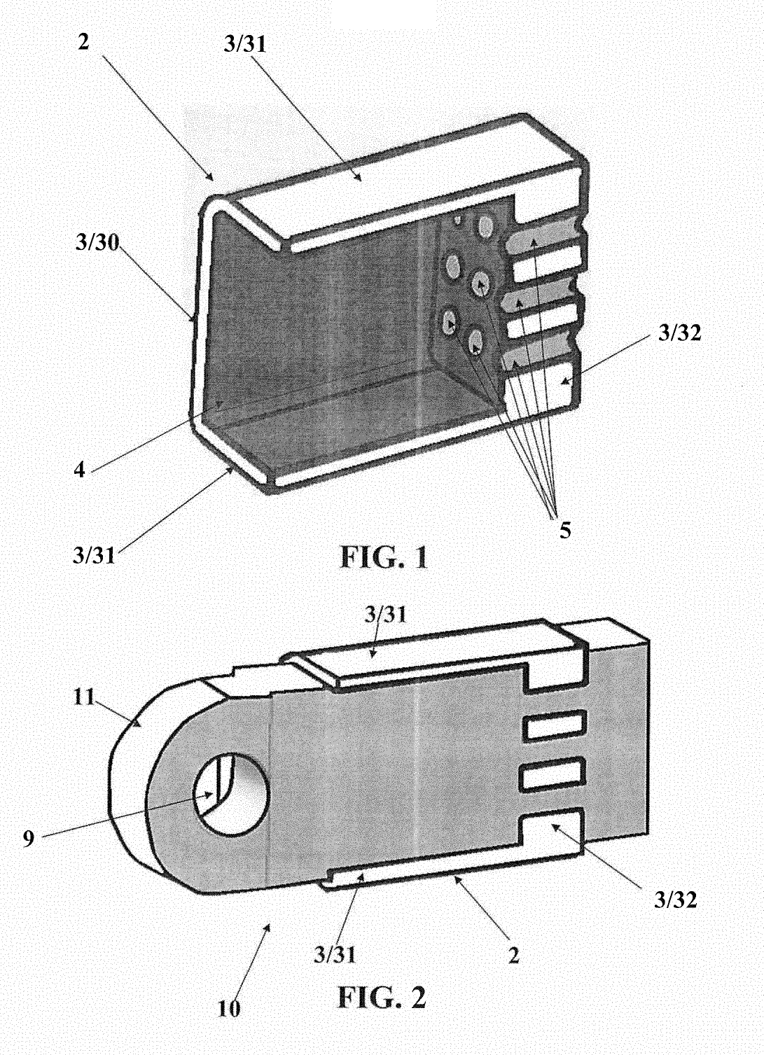

### DETAILED DESCRIPTION OF THE INVENTION

The present invention is related to the field of manufacturing electrical connecting devices intended to ensure an electrical connection of at least one electrical cable with at least another electrical cable, namely at least part of the electrical cables of at least one bundle of electrical cables each with at least another electrical cable of at least another bundle of electrical cables.

Such an electrical connecting device 1 includes a housing 2, which is made of an electrical insulating material, and which has an inner surface oriented towards the inside of this housing 2 and, on the other hand, an outer surface oriented towards the outside of this housing 2.

This housing 2 includes walls 3, namely a bottom wall 30 (forming the bottom of this housing 2), longitudinal walls 31 (extending from the bottom wall 30) and at least one side wall 32 (extending from the bottom wall 30, from the longitudinal walls 31, and connecting these longitudinal walls 31).

These walls (3, 30, 31, 32) each have, on the one hand, an inner surface oriented towards the inside of the housing 2 and, on the other hand, an outer surface oriented towards the outside of this housing 2.

Such a housing 2 also includes at least one cavity (4; 5).

In particular, such a housing 2 may include at least one internal cavity 4 delimited at least by the bottom wall 30, by the longitudinal walls 31, as well as by the side wall 32 or by at least one of the side walls 32.

Such a housing 2 may also include at least one through-cavity 5, which the side wall 32 or at least one of the side walls 32 includes, and which passes through such a side wall 32 or such side walls 32.

Such a housing 2 also includes a metal coating 6, which extends over at least part of the outer surface of the housing 2, namely over at least part of the outer surface of at least part of the walls (3, 30, 31, 32) of this housing 2, more particularly over at least part of the outer surface of the bottom wall 30 and of the longitudinal walls 31, preferably over the entire outer surface of this bottom wall 30 and of these longitudinal walls 31.

Such a metal coating 6 is formed by a layer of metal or metal-containing alloy, such a layer covering said at least part of the outer surface of the housing 2.

Such a metal coating 6 forms an electrical conductive area and permits to achieve an insulation (more particularly electrical insulation) of the housing 2 against the electromagnetic waves.

In this respect, it should be observed that this metal coating 6 permits to insulate the housing 2 against the electromagnetic waves outside the housing 2, so as to preserve the quality of an electrical signal conveyed inside this housing 2. This metal coating 6 also permits to perform an insulation of the housing 2 against the electromagnetic waves inside this housing 2, so as to preserve the quality of an electrical signal within an electrical component external to the housing 2.

Another feature consists in that said electrical connecting device 1 may also include at least one electrical connecting means configured to ensure an electrical connection of at least one electrical cable (associated with this electrical connecting device 1 and with such an electrical connecting means) with at least another electric cable (namely associated with this electrical connecting device 1 or another electrical connecting device). Such electrical connection means can be configured to ensure the electrical connection of at least part of the electrical cables of at least one bundle of electrical cables (associated with this electrical connecting device 1) each with at least another electrical cable of at least another bundle of electrical cables (namely associated with this electrical connecting device 1 or another electrical connecting device).

Alternatively or additionally, such an electrical connecting device 1 can include at least one receiving means 7 configured to receive at least one such electrical connection means and/or at least one electrical cable (namely associated with such an electrical connecting means), an electrical connection of which must be ensured.

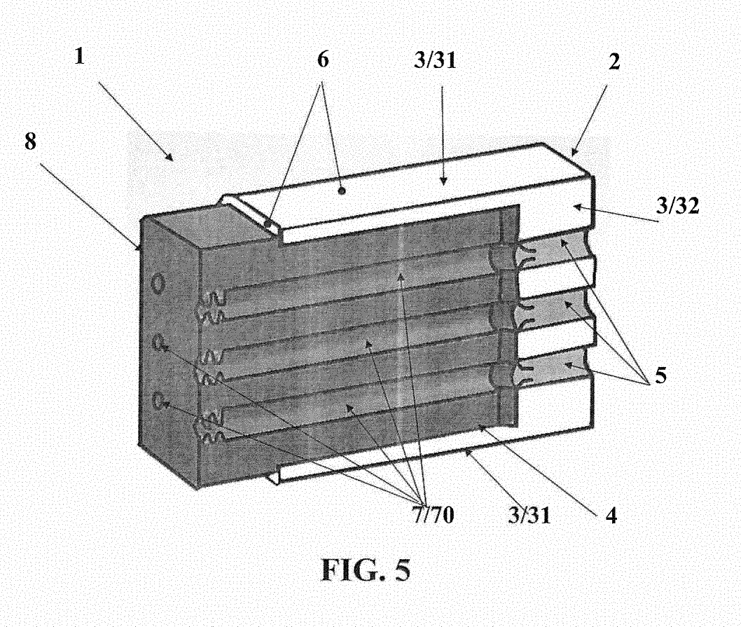

According to a particular embodiment shown in FIG. 5, such an electrical connecting device 1 can also include an insert 8 positioned at least inside the internal cavity 4 of the housing 2 (even inside the through-cavity 5 or at least one of the through-cavities 5 of this housing 2) and including at least one such receiving means 7.

In this respect, it should be observed that such an insert 8 can then be overmolded on the housing 2, more particularly inside this housing 2, namely at least inside the internal cavity 4 of the housing 2 (even inside the through-cavity 5 or at least one of the through-cavities 5 of the housing 2).

As regards said receiving means 7, it can be formed of at least one orifice 70 passing through said insert 8 and ending in front of one of the through-cavities 5 of the housing 2.

Such an orifice 70 can then be designed to receive at least one electrical cable (not shown), even at least one connecting means (not shown) associated with such an electric cable.

The invention also relates to a method for insulating a housing 2 of an electrical connecting device 1 against the electromagnetic waves.

Such a housing 2 has at least part (or preferably all) of the above-described features, namely the fact that it is made of an electrical insulating material and includes at least one cavity (4; 5).

This method for insulating consists in that:
the cavity or cavities (4; 5) of the housing 2 of the electrical connecting device 1 are closed;
at least part of the outer surface of this housing 2 is then metallized.

In fact, this method for insulating consists in that:
the cavity or cavities (4; 5) of the housing 2 of the electrical connecting device 1 are closed by overmolding an overmolding material on this housing 2;
after metallization, the overmolding material and the housing 2 of the electrical connecting device 1 are separated.

In this respect, it should be observed that the overmolding material is overmolded by injecting this overmolding material at least into (even and preferably through) the cavity (4; 5) or the cavities (4; 5) of the housing 2 of the electrical connecting device 1.

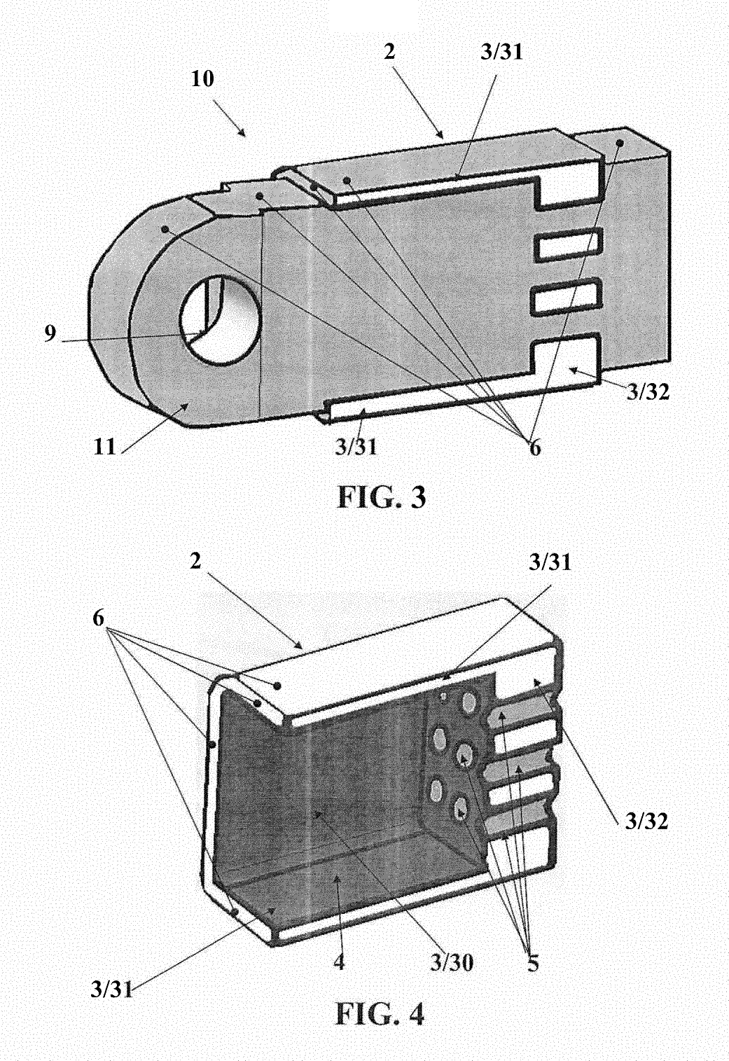

More particularly, this overmolding material is injected into the internal cavity 4 of this housing 2 as well as into the through-cavity 5 or at least one of the through-cavities 5 of this housing 2, namely of all the through-cavities 5 of this housing 2. A preferred embodiment shown in FIGS. 2 and 3 consists in that this overmolding material is injected into the internal cavity 4 of this housing 2 as well as through the through-cavity 5 or at least one of the through-cavities 5 of the housing 2, namely all the through-cavities 5 of this housing 2.

According to another feature, the overmolding material is a silicone.

As mentioned above, at least part of the outer surface of the housing 2 of the electrical connecting device 1 is metallized.

In this respect, it should be observed that at least part of the outer surface of at least part of the walls (3, 30, 31, 32) of this housing 2, more particularly at least part of the outer surface of the bottom wall 30 and of the longitudinal walls 31, preferably the entirety of the outer surface of this bottom wall 30 and of these longitudinal walls 31, is metallized.

In fact, the method also consists in that at least part of the outer surface of the overmolding material is metallized (FIG. 3).

In addition, this portion or these portions of the outer surface of the housing 2 (even at least part of the outer surface of the overmolding material) are metallized by coating (more particularly by covering) with a layer of metal or a metal-containing alloy.

This metallization permits, in particular, to define the above-described metal coating 6.

Another feature of the method for insulating consists in that means 9 for receiving an organ for handling and/or holding the electrical connecting device housing 1 are defined.

In fact, the receiving means 9 are defined when the overmolding material is overmolded on the housing 2 of the electrical connecting device 1.

The method for insulating also consists in that, after metallization, the overmolding material and the housing 2 of the electrical connecting device 1 are separated by cutting the overmolding material, more particularly by cutting the overmolding silicone.

The invention then also relates to a housing 2 of an electrical connecting device 1.

This housing 2 has at least part (or preferably all) of the above-described features.

In particular, this housing 2 is made of an electrical insulating material and includes at least one cavity (4; 5).

More particularly, this housing 2 is obtained by implementing the above-described method for insulating.

The invention also relates to an electrical connecting device 1, which has at least part (or preferably all) of the above-described features.

In particular, this electrical connecting device 1 includes a housing 2, which is made of an electrical insulating material, which includes at least one cavity (4; 5), and which is obtained by implementing the above-described method for insulating.

Such an electrical connecting device 1 also includes at least one insert 8, which has the above-described features.

In particular, such an insert 8 includes at least one receiving means 7 configured to receive at least one electrical connecting means and/or at least one electrical cable (namely associated with such an electrical connecting means), an electrical connection of which must be ensured.

Such an insert 8 extends at least inside at least one of the cavities (4; 5) of the housing 2, more particularly at least inside the internal cavity 4 of this housing 2.

The invention also relates to an assembly 10 including, on the one hand, a housing 2 of an electrical connecting device 1. This housing 2 has at least part (or preferably all) the above-described features, in particular that it is made of an electrical insulating material and that it includes at least one cavity (4; 5).

On the other hand, this assembly 10 includes means for closing 11 the cavity (4; 5) or cavities (4; 5) of the housing 2, these closing means 11 being formed by an overmolding material, which is overmolded on this housing 2 of an electrical connecting device 1, and which extends at least inside (even through) the cavity or cavities (4; 5) of the housing 2.

In this assembly 10, the overmolding material is a silicone.

Such an assembly 10 is obtained after implementing at least part of the steps of the above-mentioned method for insulating, namely after implementing a step of overmolding the overmolding material on the housing 2. Such an assembly 10 has been shown in FIG. 2.

This assembly 10 also includes a metal coating 6, which extends over at least part of the outer surface of the housing 2 and/or over at least part of the outer surface of the closing means 11.

In fact, such an assembly 10 is obtained after implementing at least part of the steps of the above-mentioned method for insulating, namely after implementing a step of metallizing at least part of the housing 2 and at least part of the closing means 11.

Such an assembly 10 has been shown in FIG. 3.

As regards this metal coating 6, it extends over at least part of the outer surface of the housing 2 and then forms means for insulating the housing 2 against the electromagnetic waves.

This metal coating 6 has the above-described features. In particular, this metal coating 6 is formed by a layer of metal or a metal-containing alloy. This metal coating 6 covers at least part of the outer surface of the housing 2 and has been deposited by metallization according to a step of the above-mentioned method for insulating.

In addition, this assembly 10 may also include the means for receiving 9 an organ for handling and/or holding the housing 2 of the electrical connecting device 1. More particularly, the closing means 11 include such receiving means 9.

1. A method for insulating a housing of an electrical connecting device against electromagnetic waves, said housing being comprised of an electrical insulating material and at least one cavity, said method comprising the steps of:
closing the cavity; and
metallizing at least part of an outer surface of said housing,
wherein
the cavity is closed by overmolding an overmolding material on said housing, and
wherein said overmolding material and said housing are separated, after the step of metallizing.

2. The method for insulating according to claim 1, wherein the overmolding material is overmolded by injecting said overmolding material at least into the cavity.

3. The method for insulating according to claim 1, wherein the overmolding material is comprised of silicone.

4. The method for insulating according to claim 1, wherein at least part of the outer surface of the housing of the electrical connecting device is metallized by coating said portion of the outer surface with a layer of metal or a metal-containing alloy.

5. The method for insulating according to claim 1, wherein means for receiving an organ for handling and/or holding the housing of the connecting device electric are defined.

6. The method for insulating according to claim 5, wherein the receiving means are defined when overmolding material is overmolded on the housing of the electrical connecting device.

7. The method for insulating according to claim 1, wherein the overmolding material and the housing of the electrical connecting device are separated by cutting this overmolding material.

8. A housing of an electrical connecting device, comprising:
a housing body being comprised of an electrical insulating material; and
at least one cavity.

9. An electrical connecting device, comprising:
a housing according to claim 8.

10. The electrical connecting device according to claim 9, further comprising:
at least one insert being comprised of at least one receiving means configured to receive at least one electrical connecting means and/or at least one electrical cable the electrical connection of has to be ensured.

11. An assembly, comprising:
a housing of an electrical connecting device, said housing being comprised of an electrical insulating material and including comprising at least one cavity; and
means for closing the cavity,
wherein the closing means are formed by an overmolding material, which is overmolded on said housing and extends at least inside the cavity.

12. The assembly, according to claim 11, wherein the overmolding material is comprised of silicone.

13. The assembly, according to claim 11, further comprising: a metal coating extending over at least part of the outer surface of the housing and/or over at least part of the outer surface of the closing means.

14. The assembly, according to claim 13, wherein the metal coating is formed by a layer of metal or metal-containing alloy.

15. The assembly, according to claim 11, further comprising: means for receiving an organ for handling and/or maintaining the electrical connection housing.
